(19) United States
(12) Patent Application Publication
(10) Pub. No.: US 2025/0087909 A1
(43) Pub. Date: Mar. 13, 2025

(54) Grounding Lug and Clamp

(71) Applicant: Unirac, Inc., Albuquerque, NM (US)

(72) Inventors: Jonathan Neal, Albuquerque, NM (US); Abijith Sudhaker, Hyderabad (IN)

(21) Appl. No.: 18/826,935

(22) Filed: Sep. 6, 2024

Related U.S. Application Data
(60) Provisional application No. 63/537,100, filed on Sep. 7, 2023.

(51) Int. Cl. H01R 4/34; H01R 4/64

(52) U.S. Cl. CPC H01R 4/34; H01R 4/64

(57) ABSTRACT

A clamp system includes a grounding plate, a retainer, and a nut. The grounding plate has a first opening to receive a fastener. The retainer has a second opening. The nut fits inside of the retainer and has a third opening configured to receive the fastener.

### CROSS-REFERENCE TO RELATED APPLICATION

This application claims priority to and the benefit of the earlier filing of U.S. Provisional Application No. 63/537,100, filed on Sep. 7, 2023, which is incorporated by reference herein in its entirety.

### BACKGROUND

The rapid growth of solar photovoltaic (PV) systems has led to an increased demand for efficient, reliable, and cost-effective power conversion solutions. In solar panel systems, electrical faults can occur at various points within the system, leading to potential safety hazards and reduced performance. For example, solar modules can fail due to manufacturing defects, physical damage, or degradation over time. While there are numerous systems available for grounding electric faults in solar panel systems, there remains a need for innovative approaches to improve their functionality and efficiency.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates a side view of a clamp system, according to an embodiment of this disclosure.

FIG. 2 illustrates a top view of the clamp system of FIG. 1, according to an embodiment of this disclosure.

FIG. 3 illustrates a bottom view of the clamp system of FIG. 1, according to an embodiment of this disclosure.

FIG. 3A illustrates a side exploded view of the clamp system of FIG. 1, according to an embodiment of this disclosure.

FIG. 4 illustrates a side view of the retainer in the clamp system of FIG. 1, according to an embodiment of this disclosure, where the orientation is shown as rotated approximately 90 degrees from the view presented in FIG. 1.

FIG. 5 illustrates an isometric side view of the retainer in the clamp system of FIG. 1, according to an embodiment of this disclosure.

FIG. 6 illustrates a bottom view of the retainer in the clamp system of FIG. 1, according to an embodiment of this disclosure.

FIG. 7 illustrates a top view of the nut in the clamp system of FIG. 1, according to an embodiment of this disclosure.

FIG. 8 illustrates a top-looking isometric view of the nut in the clamp system of FIG. 1, according to an embodiment of this disclosure.

FIG. 9 illustrates a side view of the nut in the clamp system of FIG. 1, according to an embodiment of this disclosure.

FIG. 10 illustrates a top view of a grounding plate for implementation in a clamp system, according to an embodiment of this disclosure.

FIG. 11 illustrates a side view of the grounding plate of FIG. 10, according to an embodiment of this disclosure.

FIG. 12 illustrates a bottom-looking isometric view of the grounding plate of FIG. 10, according to an embodiment of this disclosure.

FIG. 13 illustrates a bottom view of the grounding plate of FIG. 10, according to an embodiment of this disclosure.

FIG. 14 illustrates a front side view and a rear side view of a clamp assembly including the clamp system depicted in FIG. 1 with the grounding plate of FIG. 10 added, assembled according to an embodiment of this disclosure, which assembly is further shown secured to a rail and holding a grounding wire GW in place.

FIG. 15 illustrates a top view of the clamp assembly depicted in FIG. 14, according to an embodiment of this disclosure.

FIG. 16 illustrates a top view of the clamp system depicted in FIG. 1, according to an embodiment of this disclosure, which system is further shown secured to a rail and securing an MLPE.

FIG. 17 illustrates a side view of the clamp system depicted in FIG. 16, according to an embodiment of this disclosure.

FIG. 18 illustrates a cross-sectional side view of the clamp system depicted in FIG. 16, according to an embodiment of this disclosure, where the cross-section is taken at line A-A.

FIG. 19 illustrates a top view of the clamp system depicted in FIG. 1 with the grounding plate of FIG. 10 added, according to an embodiment of this disclosure, which system is further shown secured to a rail and securing both an MLPE and a grounding wire GW.

FIG. 20 illustrates a side view of the clamp system depicted in FIG. 19, according to an embodiment of this disclosure.

FIG. 21 illustrates a cross-sectional side view of the clamp system depicted in FIG. 19, according to an embodiment of this disclosure, where the cross-section is taken at line B-B.

FIG. 22 illustrates a side view of an alternative clamp system according to an alternative embodiment of this disclosure.

FIG. 23 illustrates a perspective view of the example clamp system, according to an alternative embodiment of this disclosure.

FIG. 24 illustrates a perspective view of an example clamp system according to an alternative embodiment of this disclosure.

FIG. 25 illustrates a method of installing an example clamp system according to an embodiment of this disclosure.

### DETAILED DESCRIPTION

Systems and devices described herein are related to a lug clamp configured to connect to a modular rail system for grounding and securing grounding wire GWs and/or cables, as well as electronic componentry, including MLPEs, relative to the modular rail system. For the convenience of this disclosure, a rail system may include an extruded metal rail system, such as shown and described in U.S. Pat. No. 12,074,558, the entirety of which is hereby incorporated by reference.

In an embodiment, the clamp system may include a nut, a retainer, a fastener (e.g., a threaded bolt, screw, etc.), and, where needed, a grounding plate.

In an embodiment, an installation process of the clamp system may include the following: the nut may be positioned within the retainer by inserting the nut into an opening that extends laterally through the lower portion of the retainer; the fastener may be inserted vertically through an aperture in both the retainer and the nut, securing the nut lightly in place within the lateral opening of the retainer; the assembled clamp system (including the retainer, nut, and fastener) may be inserted into an open channel of a rail, which allows for selective positioning of the retainer along a length of the rail; to secure the nut and other components in the selected position, the retainer may be twisted so that rotational stops engage the shoulders of the rail laterally, which pulls the nut into an initially loose fitment against the underside of the rail's shoulders; and then, the fastener may be rotated to draw the nut into a secure position while pressing the retainer against the upper side of the rail's shoulders. Once the fastener is tightened, one or more large protrusions (e.g., serrations, detents, textural features, or three-dimensional geometric shapes) on the top surface of the nut begin to penetrate the anodized coating on the underside of the shoulders of the rail, thereby further securing the system in place and creating an electrical connection between the rail and the nut. An MLPE held by an attachment bracket may be included, and the attachment bracket may be positioned between the head of the bolt and the retainer, connected to the rail, and then the bolt is rotated to secure the MLPE to the rail. The lower surface of the head of the bolt may also have serrations to engage with the MLPE attachment bracket and create an electrical connection. Ultimately, the rail is electrically connected or bonded to the MLPE. In this secured position, friction between the clamp system and the rail prevents any movement of the clamp system and any components (e.g., MLPE, grounding wire) attached thereto. The clamp system may also be equipped with a grounding plate to secure and electrically connect/bond one or more wires or components to the rail.

The geometry of the clamp system may include sharp structural features that, when tightened, pierce coating if it has been applied to the rail. This action assists in maintaining the clamp in a selected position on the rail and breaks through the anodization, providing electrical continuity and bonding between the rail, the clamp nut, and the entire clamp assembly.

In an embodiment, the clamp system described herein offers several advantages including but not limited to: the clamp system described herein is configured to electrically bond metal components, providing a reliable pathway for fault currents in the event of an electrical fault. This enhances the overall safety of the solar PV system by effectively grounding potential fault currents. Moreover, the clamp system is capable of simultaneously securing and positioning electrical components such as MLPE and ground wires relative to the rail system when needed. This dual functionality not only streamlines the installation process but also ensures optimal placement and stability of these components. Furthermore, the clamp system allows for a releasable connection of one or more wires, such as grounding wire GWs. This may be achieved by loosening a fastener, clamping the grounding wire GW, and then adjusting its position as necessary, providing flexibility and ease of maintenance.

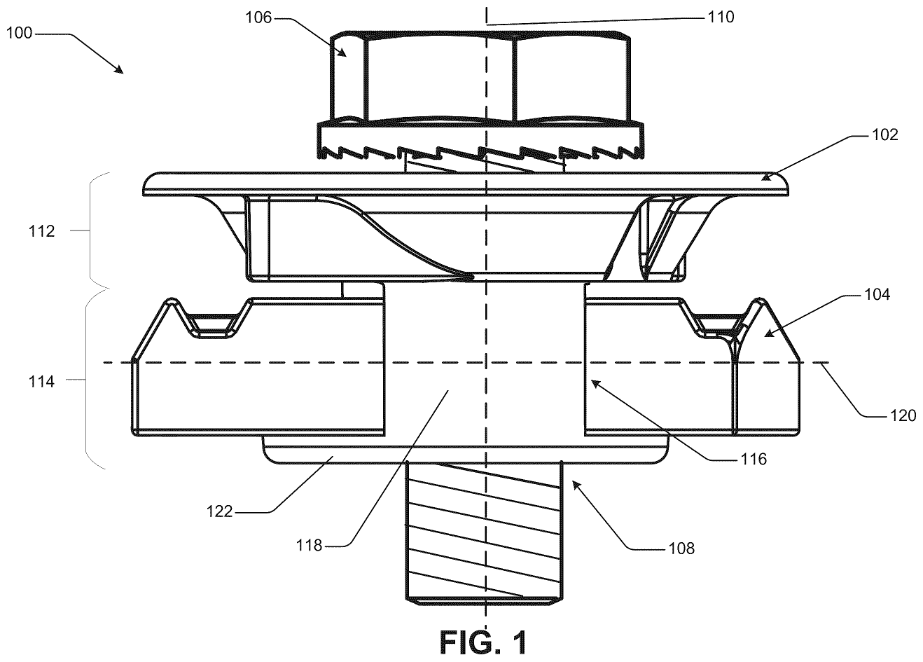

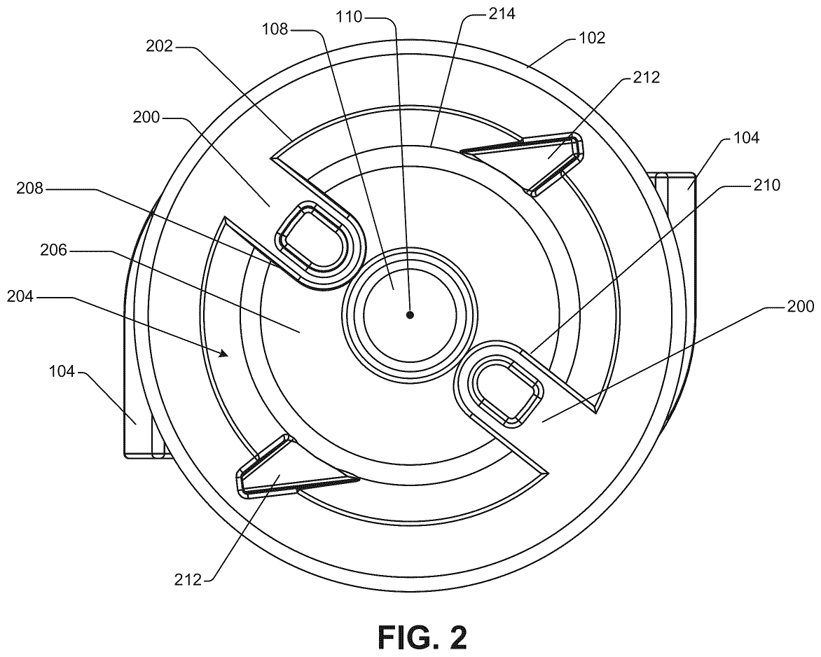

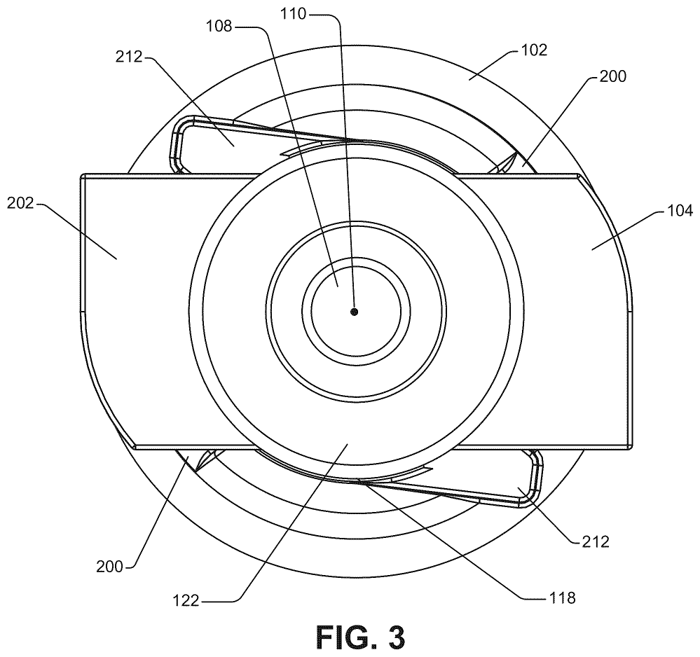

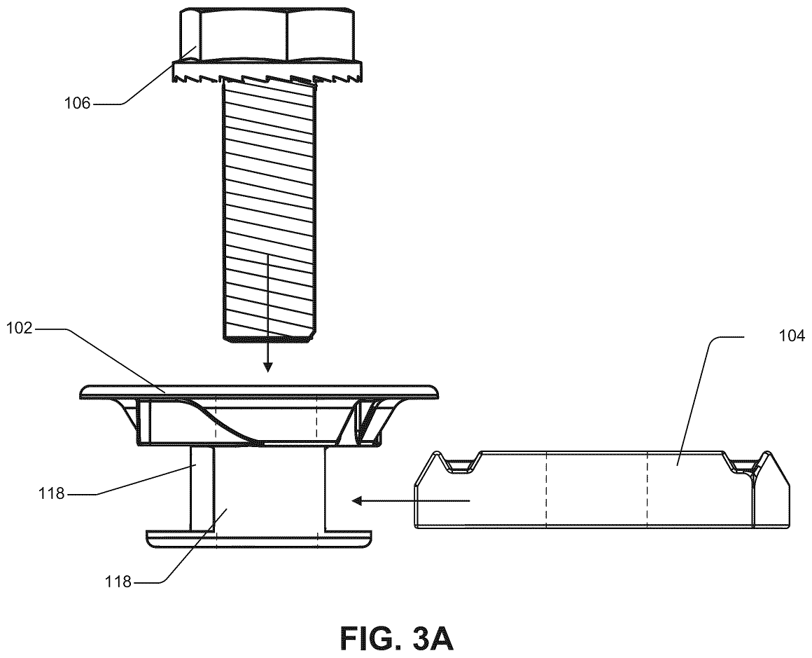

FIG. 1 illustrates a side view of a clamp system 100, according to an embodiment of this disclosure. In an embodiment, the clamp system 100 may include a retainer 102 and a nut 104 that is insertable in the retainer 102. The clamp system 100 may further include a fastener 106 that connects the retainer 102 to the nut 104 via an opening 108 (see FIGS. 2 and 3 also) that extends through the retainer 102 and the nut 104 along a central axis 110.

In an embodiment, the retainer 102 may include a first portion 112 (i.e., upper portion) and a second portion 114 (i.e., lower portion) connected to or formed integrally to extend from the first portion 112. While the first portion 112 includes several features, details of the features of the first portion 112 are described hereinafter with respect to the figures in which those features are better visualized, such as FIGS. 2-6. With respect to the second portion 114, a lateral passageway 116 may extend between opposing sidewalls 118 (with only one sidewall 118 visible in this side view of FIG. 1). The lateral passageway 116 may extend along an axis 120, as shown in FIG. 1, and may be further bounded in the vertical direction by the first portion 112 at the top side and by a base rest 122, on which the nut 104 may be set when inserted. Such a configuration may facilitate the retainer 102 to effectively receive and securely hold the nut 104 in place during installation.

FIGS. 2 and 3 provide detailed views of clamp system 100, according to FIG. 1, with the nut 104 inserted in the retainer 102, from the top and bottom perspectives, respectively. Note, the fastener 106 is not shown in FIGS. 2 and 3 in order to illustrate how the retainer 102 and the nut 104 align to form the coaxial opening 108 at axis 110 (shown as a point in FIGS. 2 and 3), which opening 108 is sized to accommodate the fastener 106.

A challenge encountered during installation of traditional rail nut attachments is the lack of physical access to the nut 104 from inside the rail. This limitation has led to the traditional nut inadvertently falling into the rail channel, complicating the assembly process and potentially compromising the stability of the system. In an embodiment according to the instant disclosure, however, the retainer 102 serves a role as an intermediary component, maintaining the nut 104 in the proper position while allowing the fastener 106 to secure the entire clamp system onto a rail.

In this configuration, the nut 104 is positioned to rest firmly on the base rest 122 of the retainer 102, which prevents it from shifting or dropping during installation.

FIG. 2 illustrates a top view of the nut 104 inserted in the retainer 102 in the example clamp system 100, as depicted in FIG. 1, according to an embodiment of this disclosure. In FIG. 2, the first portion 112 of the retainer 102 may include one or more internally-extending interior protrusions 200 that function as both grips and stops, respectively. As shown, two interior protrusions 200 are positioned on the upper side of the retainer 102, protruding inwardly toward the opening 108 and opposed from each other. In an embodiment, the interior protrusions 200 extend inwardly from a first inner edge 202 of a centrally located void 204 in the retainer 102 and protrude upwardly from a lower inside surface 206 of the void 204 also. Though FIG. 2 shows two interior protrusions 200, it should be understood that there may be additional or fewer numbers of interior protrusions 200 in the retainer 102. This configuration allows users to conveniently insert their thumb and forefinger into the void 204 of the retainer 102. That is, by pressing against opposing sides 208, 210, for example, of interior protrusions 200, a user may apply rotational force. When the user twists their thumb and forefinger in a rotational direction, the interior protrusions 200 facilitate the rotation of the retainer 102.

In an embodiment as shown in FIG. 2, the retainer 102 may further include one or more rotational stops 212 configured to limit the rotational movement of the retainer against inner surfaces of a rail when engaged with a rail. Notably, FIG. 2 shows the negative of the rotational stops 212, meaning that from the top side, the relief of the structure shape is visible, whereas the positive projections of the shape of the rotational stops 212 is visible from the bottom and lateral side views. Thus, as further seen in FIGS. 3-6, in an embodiment, the rotational stops 212 may protrude outwardly from a second inner edge 214 of the void 204 in the retainer 102, and the rotational stops 212 may be spaced apart from each other in an opposing manner. As positioned, when the user twists their thumb and forefinger in a rotational direction, the action may continue until an outer end of the rotational stops 212 come into contact with the shoulders of the rail, effectively halting further rotation of the clamp system 100. Though FIG. 2 shows two rotational stops 212, it should be understood that there may be additional or fewer numbers of rotational stops 212 in the retainer 102.

The interior protrusions 200 may serve at least two purposes. They may function as stoppers that prevent a ground plate (discussed hereinafter) from rotating excessively during the application of torque. Second, they may act as grippers during installation, providing a secure hold for the installer. While the interior protrusions 200 are depicted as inwardly extending protrusions toward the center of the retainer 102, it is considered that other shapes, or even non-protruding embodiments may achieve a same or similar function.

FIG. 3 illustrates a bottom view of the nut 104 inserted in the retainer 102 in the example clamp system 100, according to an embodiment of this disclosure. This view shows the alignment necessary for the effective operation of the clamp system. Once the nut 104 is properly positioned and secured within the retainer 102, the opening in the nut 104 aligns properly with the corresponding opening in the retainer, collectively forming a singular, continuous opening 108. This alignment is useful because it ensures that the fastener 106 may pass through both the nut 104 and the retainer 102 without obstruction, allowing for the secure fastening of the clamp system onto the rail R.

In an embodiment, as seen in FIG. 3, the rotational stops 212 are depicted as protrusions in the bottom view. As stated above, when the rotational stops 212 encounter the shoulders of a rail, the rotational stops 212 effectively prevent further rotation of the clamp system, ensuring that the system is securely fastened in place. Further, likewise the negative relief shape of the interior protrusions 200 (i.e., the grips/stops) is partially visible from the view of FIG. 3.

In FIG. 3A, an exploded side view of the example clamp system 100 of FIG. 1. FIG. 3A further shows arrows indicating: (1) the direction of insertion of the nut 104 to be positioned between the opposing sidewalls 118 of the retainer 102; and (2) the next action of the direction of insertion of the fastener 106 through the combination of the retainer 102 and the nut 104.

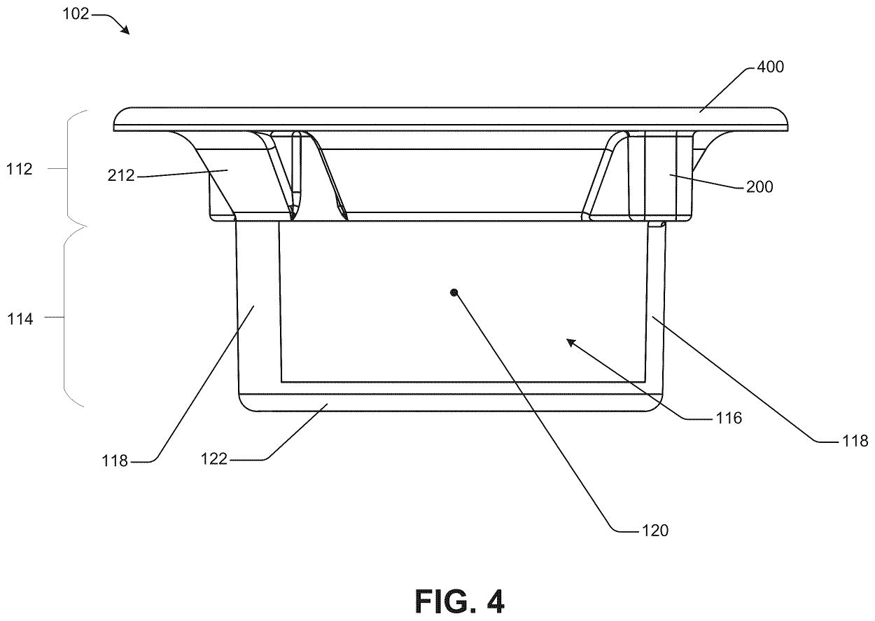

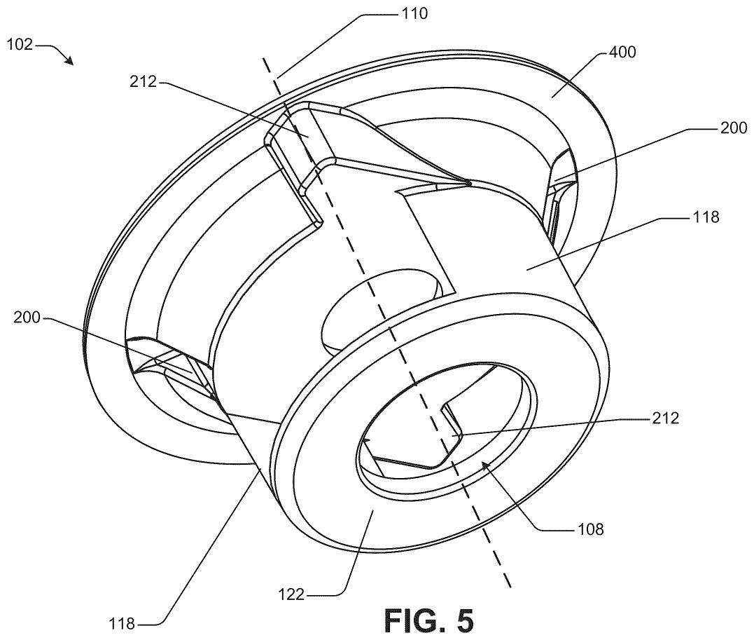

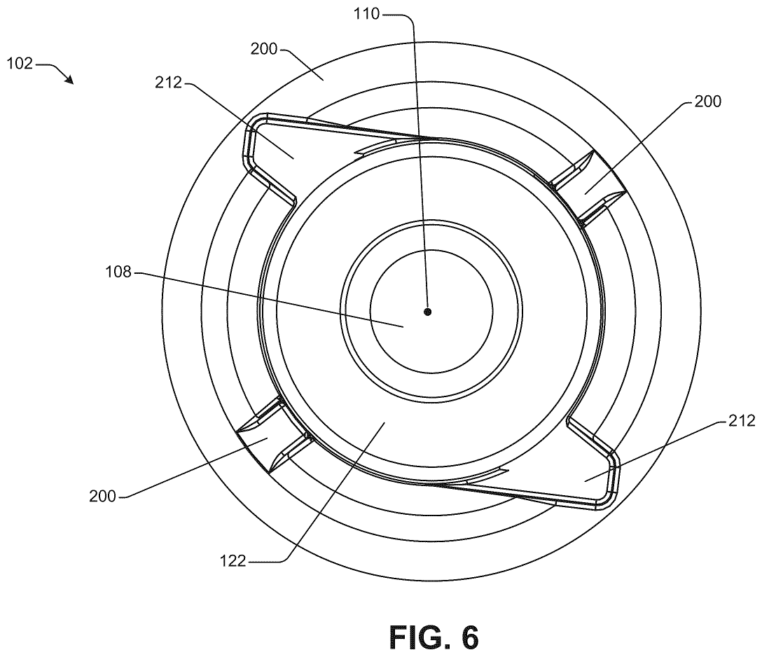

FIGS. 4-6 illustrate different views of the retainer 102 to provide clarity regarding the structural details of the retainer 102. For example, FIG. 4 illustrates a side view, FIG. 5 illustrates a perspective side view, and FIG. 6 illustrates a bottom view, of the retainer 102 in the example clamp system 100. Specifically, FIG. 4 shows an orientation of the retainer 102 when rotated from the view presented in FIG. 1, with the nut 104 removed from the opening 126. The first portion 112 has an upper rim 400 having a circular diameter (or another outer peripheral shape) that is sized to rest securely on at least part of the rail upon installation, allowing the upper rim 400 of the retainer 102 to be positioned outside the rail. Such positioning is helpful for maintaining stability and ensuring that the retainer 102 may effectively hold the nut 104 (not shown) in place during the fastening process.

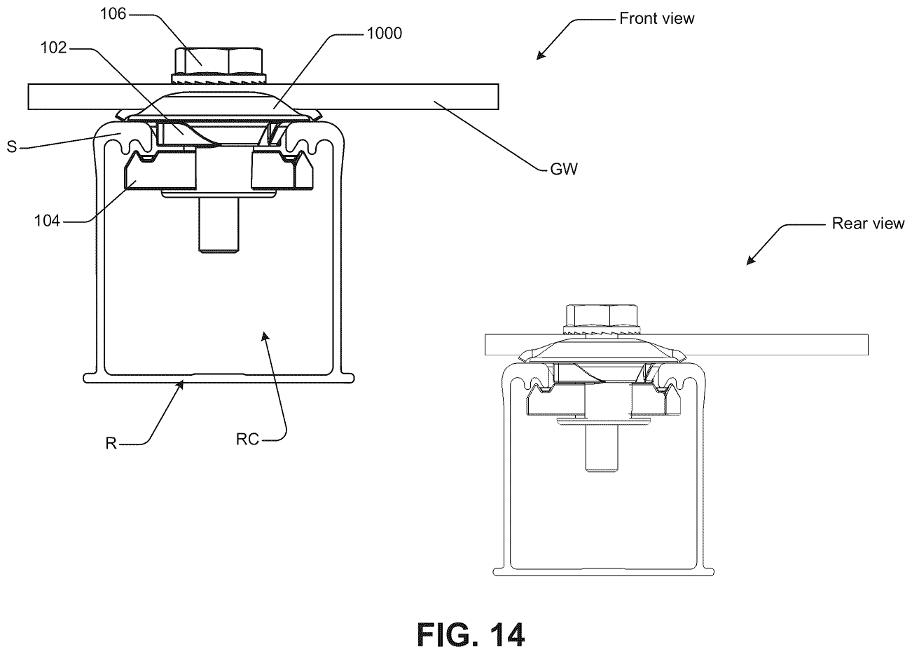

Meanwhile, the second portion 114 of the retainer 102 is configured to be suspended within the body of the rail upon installation, situated between opposing shoulders of the rail. (See FIG. 14, for example). This arrangement allows the second portion 114 of the retainer 102 to provide additional support and alignment for the fastener 106 as the fastener 106 is threaded through the retainer.

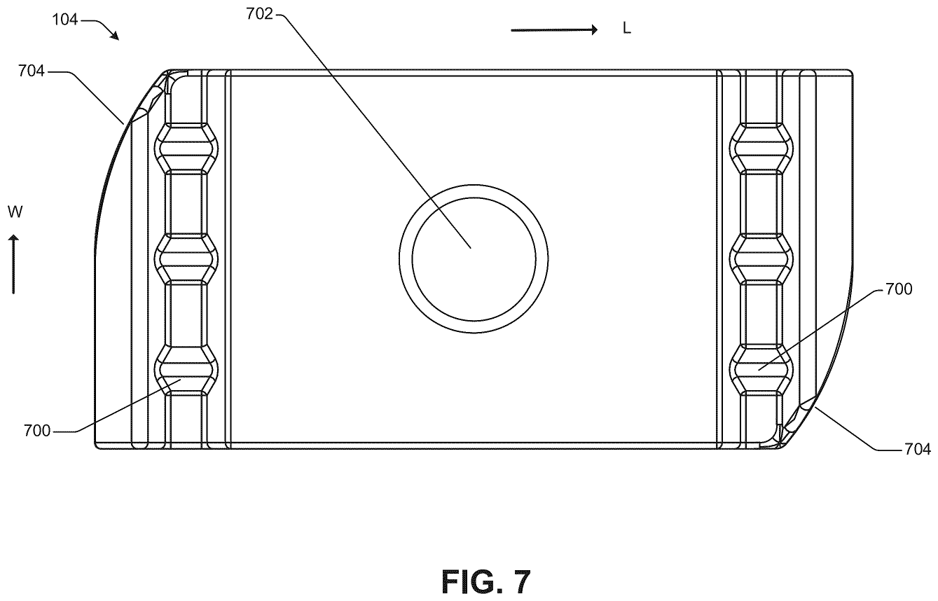

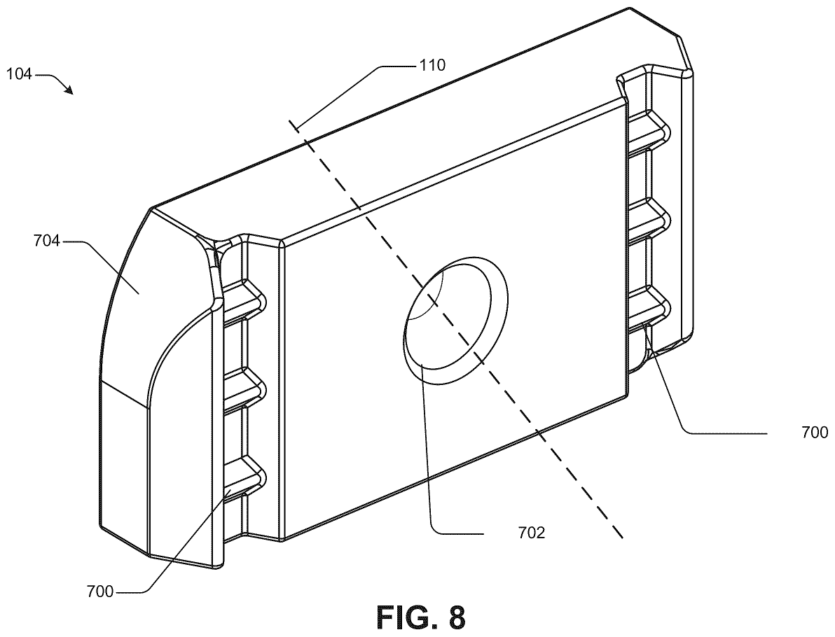

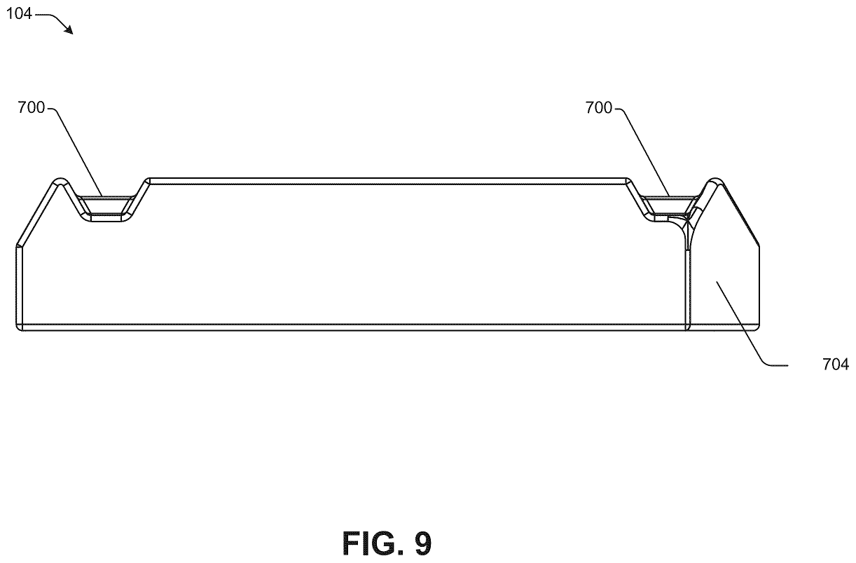

FIGS. 7-9 illustrate detailed views of the nut 104 of the example clamp system 100, according to an embodiment of this disclosure. For example, FIG. 7 illustrates a top view, FIG. 8 illustrates a top-looking isometric view, and FIG. 9 illustrates a side view, of the nut 104 in the example clamp system 100. In an embodiment, FIG. 7 illustrates a top view of the nut 104 of the example clamp system 100. The nut 104 may be an elongated member, such that a length L is sized to span a width W that is suited to accommodate a distance between opposing shoulders of a rail when installed. In an embodiment, the nut 104 may include opposing rows of serrations 700 (i.e., ridges, etc.) that extend across the upper surface 702 in the width direction W of the nut 104. A distance between the opposing rows of serrations 700 may be the distance between protruding parts of the rail to which the clamp system 100 is to be attached, whereby the opposing rows of serrations 700 may engage the protruding parts and break any anodization. Furthermore, the nut may have an opening 702, sized to allow the fastener 104 to engage therewith (i.e., via a threaded interface). The configuration of the nut 104 is characterized by its geometric features, which facilitate easy manipulation and tightening during the installation procedure. FIG. 7 shows an example shape of the nut 104 and surface features that contribute to the functionality of the nut 104. For example, in an embodiment, the nut 104 may have opposing rounded or curved corners, which facilitate a smooth rotation with minimal interference to move the nut 104 into position against the rail during installation. Additionally, in an embodiment, the serrations 700 on the outer surface of the nut 104, may be specifically shaped to enhance grip and prevent slippage during installation. Example shapes of the serrations 700 may include but are not limited to triangular shape, sawtooth shape, wave-shape, V-shape, etc. The serrations 700 may be configured to be robust enough to withstand mechanical stress while ensuring a tight fit. The configuration of serrations 700 on the nut 104 may include varying depths (within the thickness of the nut 104) and patterns to maximize contact with the surface of the rail and to achieve effective force distribution. Moreover, it is considered that the plurality of serrations 700 may alternatively be a single serration or textural feature, on one or both sides of the nut.

Note that the geometry and shape of the nut 104 shown in FIG. 7-9 are exemplary and are not restrictive. Various alternative configurations may be utilized to improve the alignment and effectiveness of the nut 104 in securing components and evenly distributing applied forces. The nut 104 (as with all components discussed herein) may be manufactured from materials chosen for their durability and resistance to environmental factors, ensuring both mechanical stability and electrical reliability performance over time.

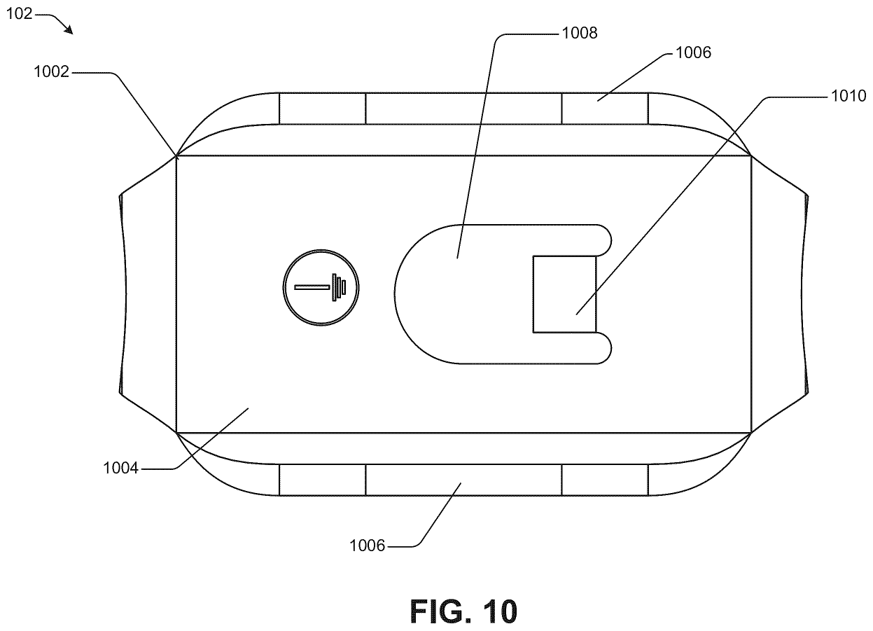

FIGS. 10-13 illustrate various views of the grounding plate 1000, which may be incorporated of the example clamp system 100, according to an embodiment of this disclosure.

In an embodiment, FIG. 10 illustrates a top view of the grounding plate 1000. The grounding plate 1000 may include an elongated body 1002 including grounding wire channels 1004, which are pathways in which a grounding wire may be secured to a rail via the clamp system 100. The pathways may be defined between a sidewall 1006 and an opening 1008. The opening 1008 is sized to accommodate a fastener 106 therein, as are the retainer 102 and the nut 104.

The grounding wire channels 1002 are configured to allow the grounding wire (not shown) to maintain a fixed position relative to the rail, by tightening the fastener 106 (not shown here) down upon the grounding wire in the grounding wire channel 1004 so as to pinch into the grounding wire. Such a configuration ensures that the grounding wire is securely contained and aligned with the grounding plate 1000, preventing accidental dislodgement and ensuring consistent electrical connectivity.

In an embodiment, the opposing sidewalls 1006 may be curved upwardly, forming raised walls designed to hold and position the electrical grounding wire, such that two adjacent grounding wire channels 1004 are available. Such a configuration ensures that the grounding wire is securely contained and aligned with the plate, preventing accidental dislodgement and ensuring consistent electrical connectivity.

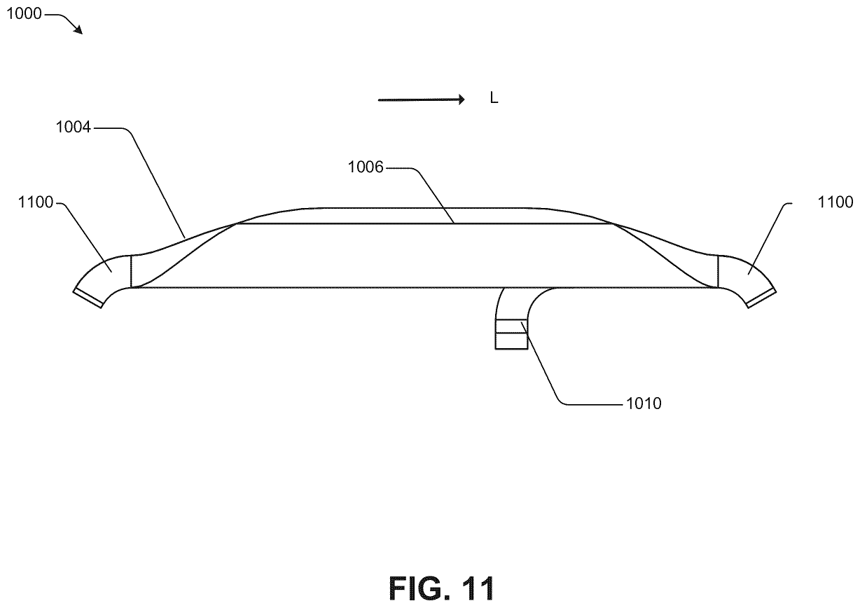

Furthermore, in an embodiment, the grounding plate 1000 may include a tab 1010 that is bent out of the plane of elongation of the body 102, through the opening 1008. See FIG. 11. In FIG. 11, a side view of the grounding plate 1000 is depicted. The grounding plate 1000 may further include downwardly curved side edges 1100, on the side in the length direction L. These side edges 1100 may be sufficiently sharp and durable to penetrate through any anodization and properly ground the solar panel system (not shown).

In an embodiment, the tab 1010 may be configured to engage/contact with retainer 102, by being caught and stopped from further rotation within the void 204 when the tab 1100 laterally and rotationally engages the protrusions 200 on the retainer 104. This stop helps to secure the grounding plate 1000 in place.

The downwardly curved edges 1100 are configured to contact the upper surface of the shoulders on a rail and/or an MLPE attachment bracket, when installed. See FIGS. 14-21. When the grounding plate 1000 is positioned atop the retainer 102 (not shown in FIGS. 10-13), the downwardly curved edges 1100 ensure a firm connection with the rail and/or the MLPE attachment bracket. Such contact helps to pierce through any anodization or coating present on the rail and/or an MLPE attachment bracket, establishing an effective electrical bond between the grounding plate, the rail, and anything therebetween.

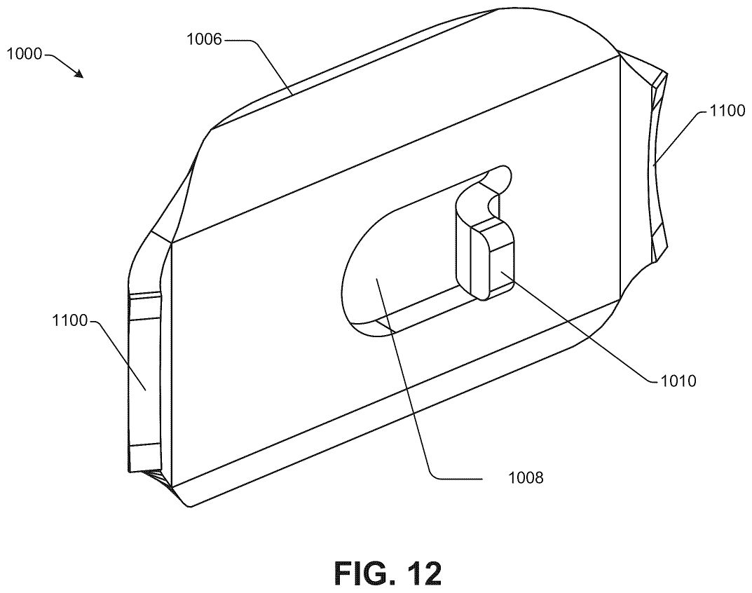

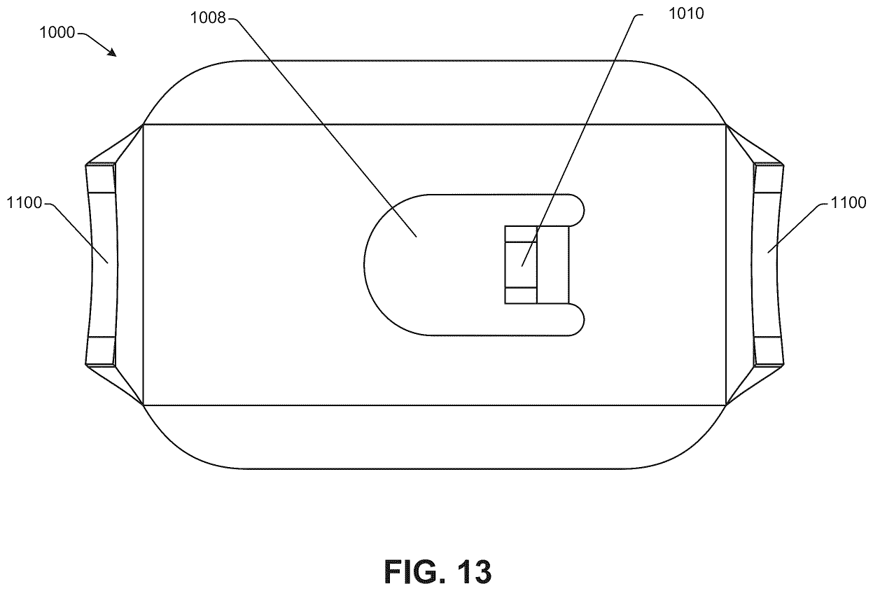

FIG. 12 illustrates a bottom-looking isometric view of the grounding plate 1000, according to an embodiment of this disclosure. FIG. 13 illustrates a bottom view of the grounding plate 1000 of the example clamp system 100, according to an embodiment of this disclosure.

Moreover, the grounding plate 1000 is configured to act as a conductor, providing a pathway for grounding electrical fault currents. Such functionality is helpful for safely directing fault currents away from sensitive components and into the rail system or support component, thereby protecting the entire setup from potential electrical hazards.

FIG. 14 provides a front side view and a rear side view of the example clamp system 100 depicted in FIG. 1, assembled with the grounding plate 1000, and securing a grounding wire GW, according to an embodiment of this disclosure. The grounding plate 1000 is shown in contact with the top portion of the rail R. FIG. 14 shows how the grounding plate 1000 aligns with and rests on the rail R, ensuring a secure connection. FIG. 14 also shows that the nut 104 may rest within the retainer 102. As the fastener 106 is tightened, the grounding plate 1000, the retainer 102, and/or the nut 104 contact with the rail R while the serrations on the head of the fastener 106 bite into the grounding wire. Moreover, the nut 104 may include a shape profile at the ends of the nut 104 to correspond with the shape of the shoulders S of the rail R (a pointed, triangular peak to fit into the open groove seen at the shoulders S of the rail R).

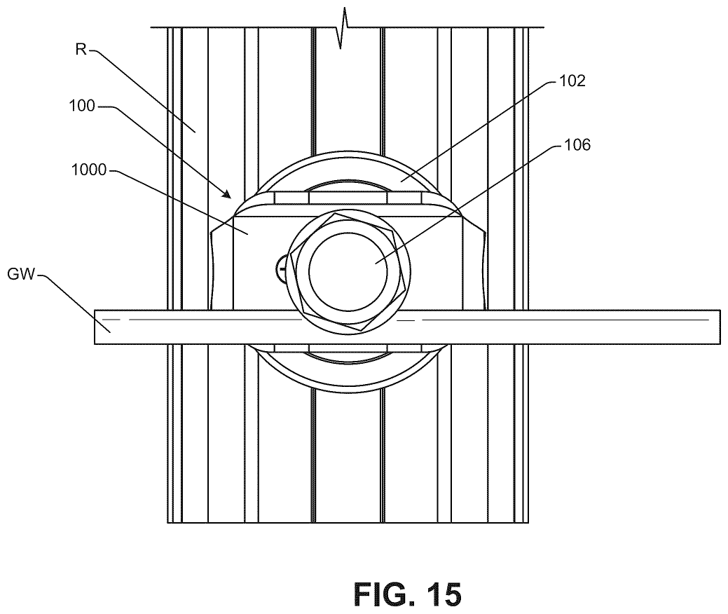

FIG. 15 illustrates a top view of the example clamp system 100 depicted in FIG. 14. This top view provides visualize the spatial arrangement and configuration of the clamp system 100, showing how the components fit together and function within the clamp system 100.

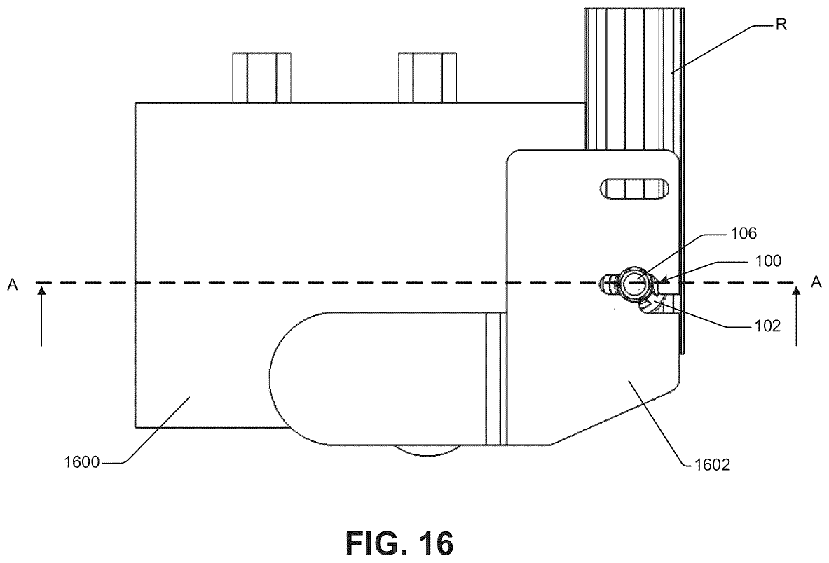

FIG. 16 illustrates a top view of an embodiment of the clamp system 100 depicted in FIG. 1, with a module level power electronics (MLPE) device and without a grounding plate or a grounding wire. This perspective allows for a detailed examination of the underlying components and their arrangement within the clamp system 100. Thus, FIG. 16 depicts a clamp system 100 securing an MLPE 1600 on an MLPE attachment bracket 1602. A portion of the retainer 102 is visible in FIG. 16. This view also facilitates an understanding of how the components interact and align with the rail R, showing the configuration and layout of the clamp system 100 from a different perspective.

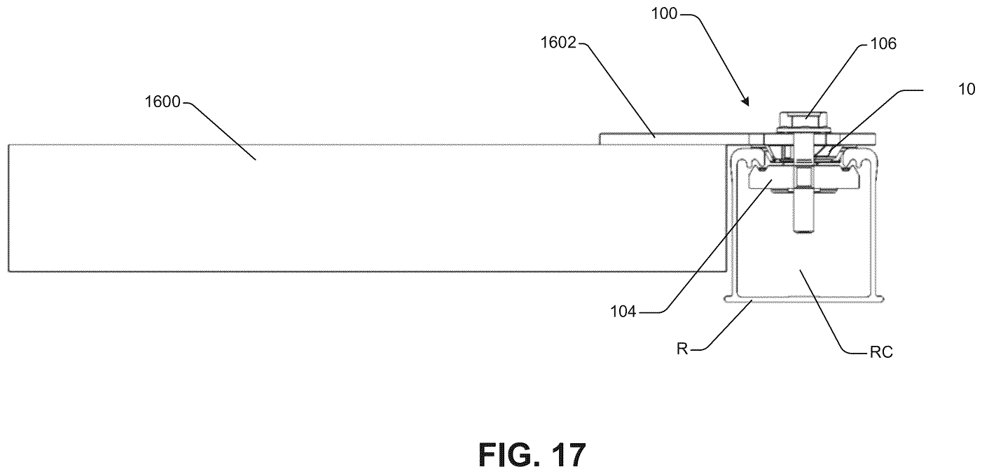

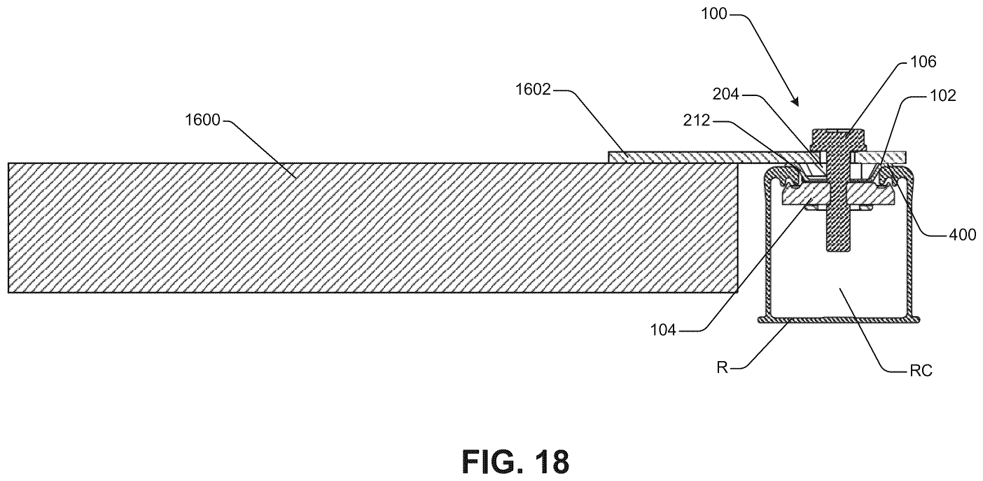

FIGS. 17 and 18 illustrate a side view and a cross-sectional side view, respectively, of clamp system 100 depicted in FIG. 16. At least a portion of the MLPE attachment bracket 1602 is shown resting directly on the upper part of the retainer 102, while the retainer 102 rests on the upper surface of the rail R to not fall into the rail channel RC.

The cross-sectional view provides some additional clarity showing the recess of the void 204 discussed with respect to FIG. 2 within the center area of the retainer 102. Prior to placing the fastener 106 in the retainer 102, it is understood that a user may use a thumb and forefinger to reach into the void 204 and engage the protrusions 200, as discussed above. Afterward, the MLPE attachment bracket 1602 may be positioned under the head of the fastener 106 via a slot in the side (see FIG. 16) of the MLPE attachment bracket 1602, for example, and the fastener 106 may be tightened. Additionally, as the first section 112 (see FIG. 1) of the retainer 102 beneath the upper rim 400 (see FIG. 4) has the greatest width dimension at the rotational stops 212 of the retainer 102, the cross-sectional view in FIG. 18 shows that the rotational stops 212 engage directly with the shoulders of the rail R.

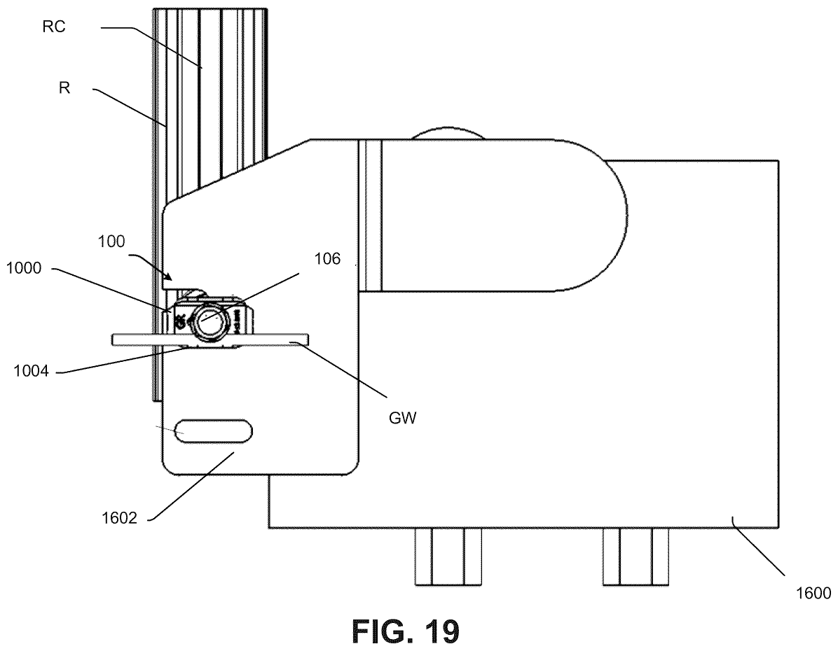

FIG. 19 illustrates a clamp system 100, with an MLPE device 1600, a grounding plate 1000, and a grounding wire GW. The clamp system 100 may provide a secure and electrically conductive connection between solar panel components and the support structures.

The grounding plate 1000 serves a dual purpose in the system. On one hand, the grounding plate 1000 provides a mechanical connection that helps to stabilize the positioning of various components. On the other hand, the grounding plate 1000 acts as a conductive surface, establishing an electrical pathway that ensures proper grounding of the solar panel system. This is significant for the safe and efficient operation of the system, as the electrical pathway helps to dissipate any stray electrical currents that might arise from electrical faults or environmental conditions, such as lightning strikes.

To fulfill the role of a conductive surface, in an embodiment, particularly when the MLPE is positioned between the rail and the grounding plate 1000 (i.e., when the assembly is used for dual functions-simultaneously as an MLPE mount and a ground wire lug), the grounding plate 1000 may be made from materials known for high electrical conductivity. Example materials may include metals such as stainless steel, copper, gold, aluminum, silver, alloys, or other conductive materials. The choice of material may depend on various factors, including cost, durability, and the specific environmental conditions in which the solar panel system is deployed. In another embodiment, where an MLPE is not installed or where the MLPE is installed on top of the grounding plate, for example, it is considered that that grounding plate may be formed of a non-conductive material. Such a situation may be where the ground path goes from a ground wire (or the MLPE mounting plate/attachment bracket) to the bolt head, through the bolt, to the rail nut, and thus to the rail.

In an embodiment, the clamp system 100 is configured to attach one or more components to the rail R securely. As illustrated in FIGS. 16-21, the MLPE 1600, also referred to as an MLPE device, may be mounted on the rail R via the MLPE attachment bracket 1602. This support component, which may include a support flange extending from the MLPE 1600 or a plate, is held in place by the clamp system 100. The MLPE attachment bracket 1602 may include one or more passages, such as aperture 1604, sized to receive the fastener 106. When the fastener 106 is tightened, the fastener 106 creates a frictional coupling between the MLPE attachment bracket 1602 and the grounding plate 1000, securing the MLPE 1600 in a fixed position relative to the rail R.

Regardless of whether the grounding plate 1000 is used directly against the surface of the MLPE attachment bracket 1602 or is also employed to secure a grounding wire GW, the grounding plate 1000 plays a role in safely grounding any electrical faults. In this configuration, the clamp system functions as a grounding lug, providing a reliable pathway for electrical fault currents. Additionally, the MLPE attachment bracket 1602 may also serve to secure one or more wires, such as the grounding wire GW, ensuring that one or more wires remain properly positioned relative to the MLPE attachment bracket 1602.

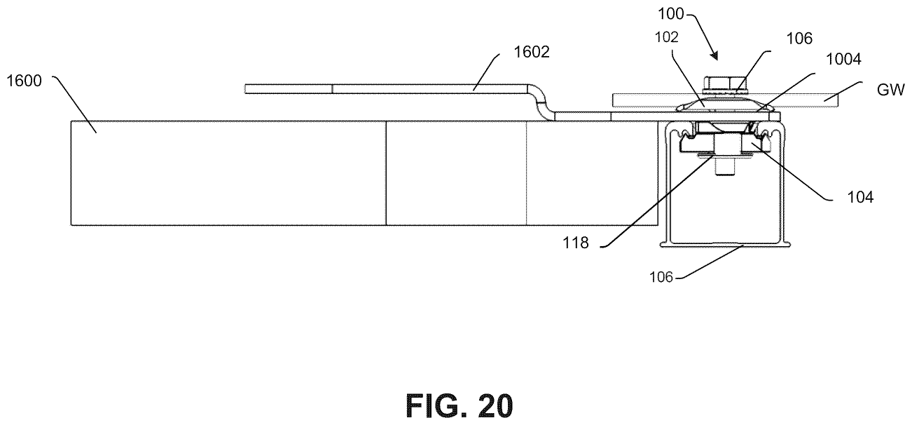

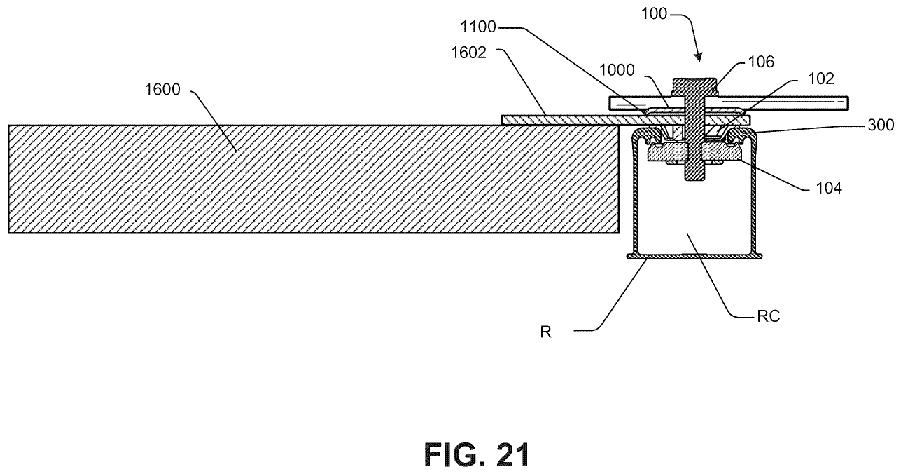

FIGS. 20 and 21 illustrate a side view and a cross-sectional side view, respectively, of the example clamp system 100 depicted in FIG. 19, according to an embodiment of this disclosure. As shown, the fastener 106 extends through both the grounding plate 1000 and the MLPE attachment bracket 1602. Once tightened, this setup allows the clamp system 100 to be securely and frictionally secured to the rail R. In an embodiment, the MLPE attachment bracket 1602 extends over the rail R, permitting the grounding plate 1000 to make contact with the surface of the MLPE attachment bracket 1602.

In addition to the features discussed above as being shown in the cross-section of FIG. 18, the cross-sectional view in FIG. 21 further depicts how the grounding plate 1000 may be positioned under the head of the fastener 106 and on top of the MLPE attachment bracket 1602. That is, the downwardly curved side edges 1100 are shown to pointedly engage and penetrate a coating, when such is applied, of a surface of the MLPE attachment bracket 1602. Simultaneously, the view in FIG. 21 shows how a ground wire GR may be held between the upper surface of the grounding plate 1000, and the serrated undersurface of the head of the fastener 106 to penetrate the ground wire GW and create an electrical bond between the various elements.

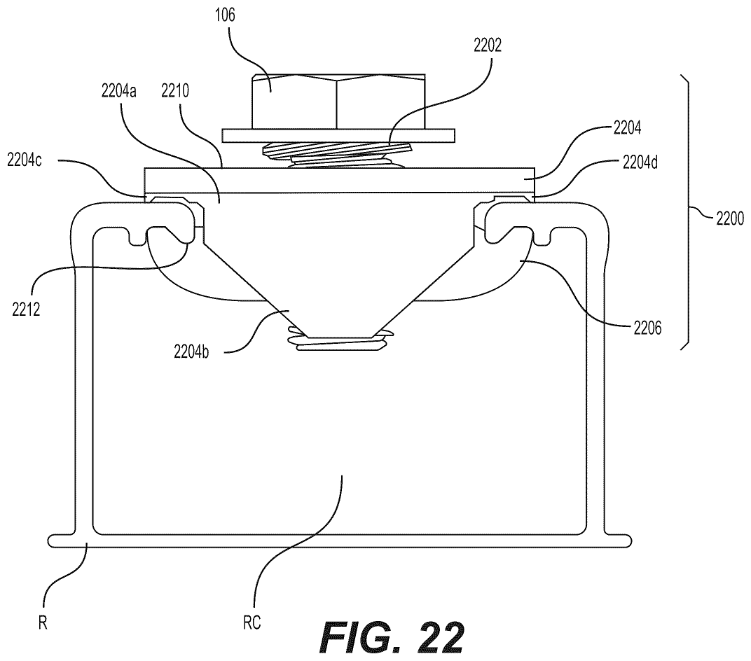

Additionally, FIG. 22-25 present various views of additional example clamp systems, illustrating additional embodiments according to this disclosure. These embodiments are grounded in the elements and features depicted in FIG. 1-21, with the same reference numbers indicating the same or similar components. This continuity highlights variations and modifications that adhere to the principles and designs outlined. These variations expand the applicability of the clamp system across different contexts and requirements.

FIG. 22 illustrates a side view of an example clamp system 2200 according to another embodiment of this disclosure. FIG. 22 shows the clamp system 2200 further connected to a rail R. In an embodiment, the clamp system 2200 may include a biasing structure such as a spring component 2202, along with a retainer 2204 and a nut 2206. The spring component 2204 may be a helical coil structure, allowing the spring component 2204 to exert consistent pressure when compressed. The spring component 2204 may be configured with a structure other than a helical coil to facilitate the spring component 2204 fitting snugly between the fastener 106 and the ground plate of the retainer 2204 to help keep the system aligned and prevent slipping.

The retainer 2204 may include an upper portion 2204a and a second portion 2204b. The first portion 2204a is configured to contact the spring component 2204 via a flat portion 2210. The second portion 2204b is configured to accommodate the fastener 106 and the nut 2206. The second portion 2204b is configured to maintain the position of the nut 2206 so that the nut 2206 may effectively pierce the surface of the rail R. The second portion 2204b is positioned within a rail channel RC inside the rail R, with the fastener 106 extending through both the first portion 2204a and the second portion 2204b of the retainer 2204.

The retainer 2204 may further include downwardly curved edges 2204c and 2204d configured to contact with the rail R.

The nut 2206 is configured to engage with the shoulders of the rail R and fit the second portion of the 2204b of the retainer 2204. The nut 2206 may include one or more textural features 2212, such as serrations or undulations which have a surface shape configured to pierce through an anodization layer on the rail R. Moreover, the textural features 2212 of the nut 2206 may include a shape profile corresponding to a shape of the shoulder of rail R.

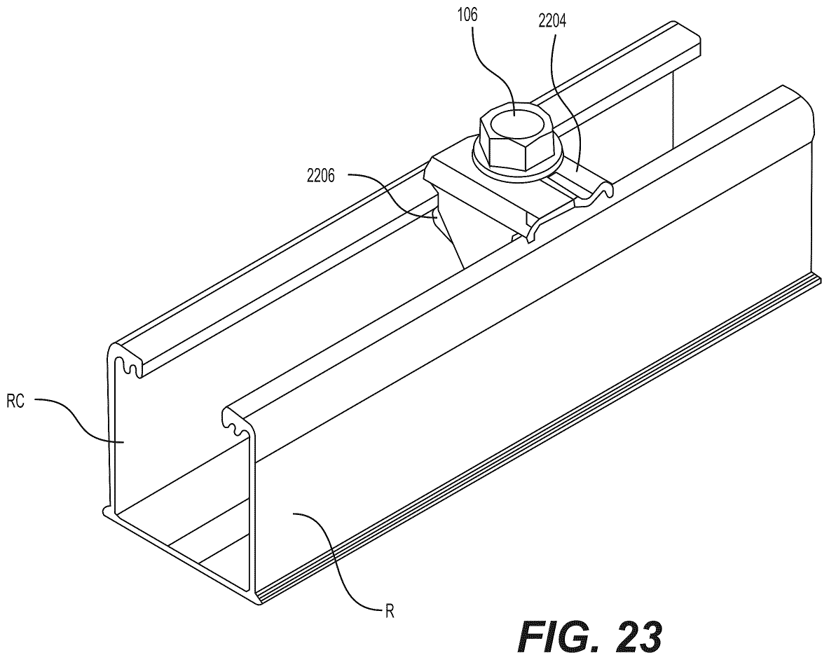

FIG. 23 illustrates a perspective view of the example clamp system 2200, and shows the fastener 106, the retainer 2204, the nut 2206, and the rail R.

Referring to FIG. 23, the fastener 106 is configured to pass through the retainer 2204 and the nut 2206 of the clamp system 2200. In an embodiment, the fastener 106 may include a threaded shaft that allows it to be tightly screwed into place, ensuring that the components it holds remain securely attached under various conditions. The head of the fastener may also feature a drive recess (such as a hex head) to facilitate easy tightening or loosening during assembly and maintenance.

The retainer 2204 is configured to hold the fastener 106 and the nut 2206 in position, ensuring proper alignment, providing stability, and preventing any unintended movement or loosening. The material of the retainer 2204 is selected for its durability and resistance to wear, ensuring long-lasting performance in various applications.

The nut 2206 is configured with a profile that allows it to seat securely against the retainer 2204. The shape and material of the nut 2206 may be chosen to provide a robust and durable connection that resists loosening due to vibrations or other external forces.

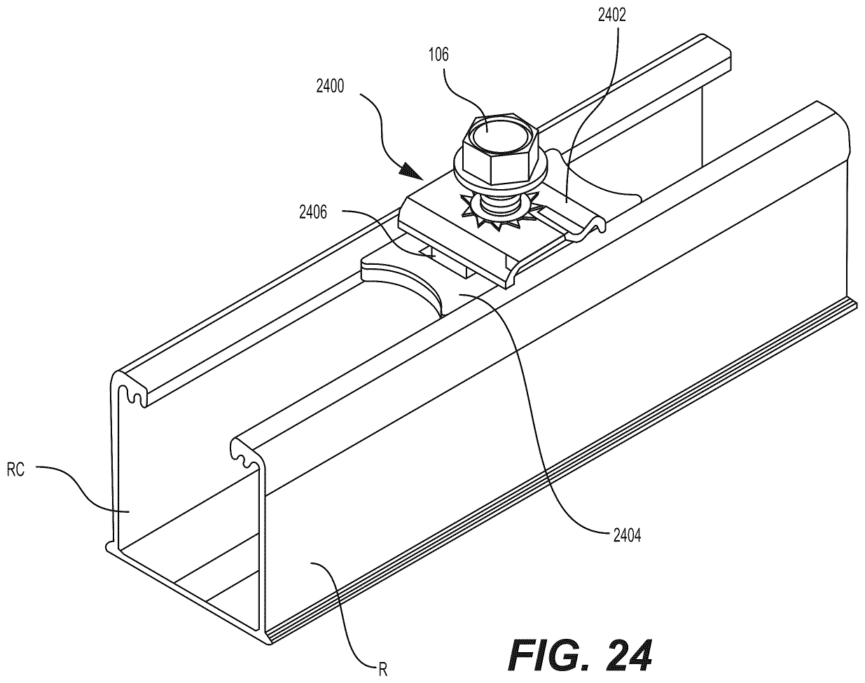

FIG. 24 illustrates a perspective view of an example clamp system 2400, according to another embodiment of this disclosure. FIG. 24 shows a fastener 106, the clamp system 2400, and a rail R. The clamp system 2400 may include a grounding plate 2402, a mounting plate 2404, a retainer 2406, and a nut (not shown).

The grounding plate 2402 is configured with an opening sized to receive the fastener 106 (e.g., a bolt, a screw, etc.). On the other hand, the grounding plate 2402 is also configured to act as a conductive surface, establishing an electrical pathway that ensures proper grounding of the solar panel system. The fastener 106 may be tightened to create a solid frictional interface between the grounding plate 2402 and the surface on which the fastener 106 rests.

The retainer 2406 is configured to maintain the position of the nut (not shown). The retainer 2406 is positioned within a rail channel RC in the rail R, ensuring contact with the rail R's surface. In an embodiment, the retainer 2406 is also coupled to the grounding plate 2402, with the fastener 106 extending through both the grounding plate 2402 and the retainer 2406.

The mounting plate 2404 is positioned between the grounding plate 2402 and the retainer 2406. The mounting plate 2404 is configured to facilitate the mounting of the clamp system 2400 to the rail. As shown in FIG. 24, the shape of the edges of the mounting plate 2404 may match the shape of the shoulders of the rail R.

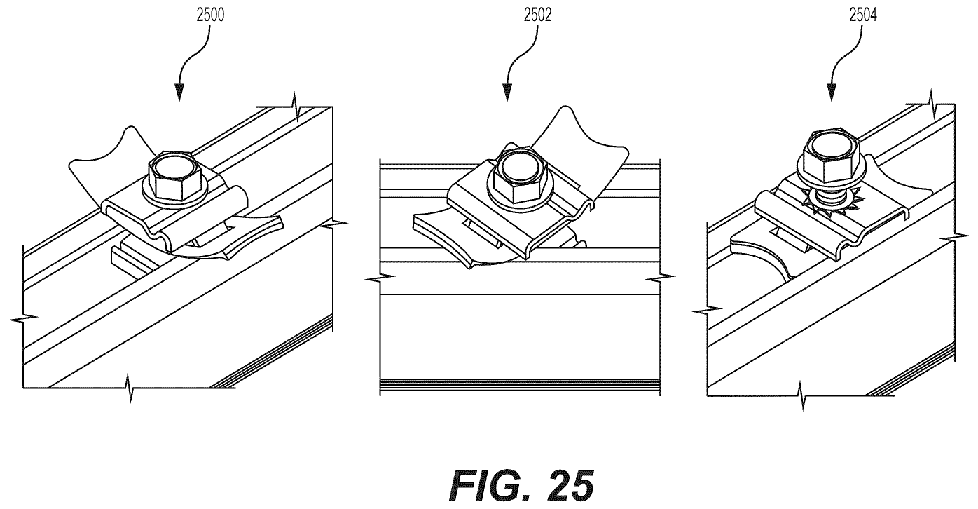

FIG. 25 illustrates three views (2500, 2502, and 2504) showing a process for installing the clamp system 2400 depicted in FIG. 24 to the rail R according to an alternative embodiment of this disclosure.

View 2500 shows that by pressing the fastener 106, the clamp system 2400 may enter the rail channel RC of the rail R, where the first edge of the mounting plate 2404 is perpendicular to the shoulder line of the rail R.

View 2502 shows that by turning the fastener 106, the components (the grounding plate 2402, the mounting plate 2404, the retainer 2406, and the nut) of the clamp system 2400 may engage with each other, where the mounting plate 2404 is in a tilted position with respect to the shoulder line of the rail R.

View 2504 shows a complete position of the clamp system 2400 in rail channel RC of the rail R. As shown in view 2504, the components (the grounding plate 2402, the mounting plate 2404, the retainer 2406, and the nut) of the clamp system 2400 are securely engaged with each other, where the edges of the mounting plate 2404 are properly engaged with the shoulders of the rail R.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications that do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative an embodiment that fall within the scope of the claims.

What is claimed is:

1. A clamp system comprising:
a grounding plate having a first opening to receive a fastener;
a retainer having a second opening; and
a nut that fits inside of the retainer, the nut having a third opening configured to receive the fastener.

2. The clamp system of claim 1, wherein the fastener extends through the grounding plate, the retainer, and the nut via the first opening, the second opening, and the third opening.

3. The clamp system of claim 1, wherein the grounding plate further includes downwardly curved edges.

4. The clamp system of claim 1, wherein the grounding plate further includes wire channels configured to accommodate a grounding wire.

5. The clamp system of claim 1, wherein the retainer further includes:
a first portion configured to rest on a rail; and
a second portion configured to be positioned within a channel of the rail.

6. The clamp system of claim 5, wherein the first portion of the retainer includes protrusions protruding inwardly from a first edge of the retainer towards the second opening of the retainer.

7. The clamp system of claim 1, wherein the retainer includes rotational stops protruding outwardly from a second edge of the retainer.

8. The clamp system of claim 1, wherein the nut includes serrations to pierce an anodized layer of a rail upon installation.

9. The clamp system of claim 1, wherein the nut includes a protrusion protruding from a surface of the nut, the protrusion being configured to engage with the retainer.

10. A clamp system comprising:
a fastener;
a retainer having a first opening; and
a nut that slides within the retainer, the retainer having a second opening;
wherein the fastener is configured to extend through the retainer and the nut via the first opening and the second opening.

11. The system of claim 10, further comprising a grounding plate that includes downwardly curved edges configured to pierce an anodization layer of a rail to contact and electrically bond with the rail.

12. The system of claim 11, wherein the grounding plate further includes wire channels configured to accommodate a grounding wire.

13. The system of claim 10, wherein the retainer further includes:
a first portion configured to rest on a shoulder of a rail, and
a second portion configured to be positioned within a channel of the rail.

14. The system of claim 13, wherein the first portion of the retainer includes grips protruding inwardly from a first edge of the retainer towards the second opening of the retainer.

15. The system of claim 10, wherein the retainer includes rotational stops configured to protrude outwardly from an edge of the retainer.

16. The system of claim 10, wherein the nut includes serrations configured to pierce an anodized layer of a rail upon installation.

17. The system of claim 10, wherein the nut includes a tab configured to engage with the retainer.

18. The system of claim 10, further comprising a grounding plate including pointed edges.

19. A clamp system comprising:
a fastener;
a retainer having a lateral opening and the retainer having a vertical opening; and
a nut sized to be inserted sideways into the retainer,
wherein the fastener is configured to extend through the retainer and the nut via the vertical opening in the retainer.

20. The system of claim 19, further comprising a grounding plate positioned between the retainer and the fastener.
